(19) United States
(12) Patent Application Publication
(10) Pub. No.: US 2012/0118179 A1
(43) Pub. Date: May 17, 2012

(54) METHOD OF ASSEMBLING A BALING APPARATUS

(75) Inventors: John Paul Creighton, Kiltimagh (IE); Eoghan Gallagher, Swinford (IE)

(73) Assignee: John Paul Creighton, County Mayo (IE)

(21) Appl. No.: 13/293,654

(22) Filed: Nov. 10, 2011

(51) Int. Cl. B30B 15/00; B30B 1/12; B23P 11/00

(52) U.S. Cl. 100/100; 29/428; 100/243; 100/245; 100/255

(57) ABSTRACT

A method of assembling a manually operated baling apparatus for compacting and bailing, comprising steps of arranging an upstanding sidewall on a base, the side wall comprising a rear side wall flanked by two lateral sidewalls, positioning a front wall between the sidewalls and applying front wall to sidewall fixing means to secure the front wall to the side walls to thereby form a chamber defined by the base, the rear side wall, the two lateral side walls and the front wall, arranging a box section member on an outer face of the rear wall and connecting compaction means to the box section member, which components may be inter-stacked as a kit for transporting in a substantially flat pack arrangement prior to assembly.

The present invention relates to a method of assembling a baling apparatus, and more particularly, a manually operated baling apparatus for compacting and baling material. The present invention further relates to a baler apparatus obtained from the method of assembly.

Industrial balers may be used to compact and bale refuse, as well as various types of waste, such as paper, cardboard, plastics, foil, cans and other like recyclable materials. Often this compacted material may be onsold to recycling companies. Such industrial balers usually comprise a chamber manufactured from steel and have an automated or manually actuated compaction system which is operable to press firmly down on material loaded into the chamber to thereby compact the material into a removable bale. Balers also have mechanisms which enable the bale to be tied before removal from the chamber.

Balers of the type having a manually operated compaction system are typically used for compacting relatively small quantities of material. However these balers, and the manufacture of such balers, suffer from a number of drawbacks which present problems to both the public and industry alike. One major problem relates to the expense involved in transporting the balers, which it will be understood is due in large part to the voluminous structure of the baler chamber. Another problem relates to the complex construction of the balers, which results not only in an expensive manufacturing process but also contributes to the steps needed for assembling a baler from its component parts being extremely time consuming.

It is a therefore an object of the present invention to provide a method of assembling a baling apparatus from component parts which goes at least some way toward overcoming the above problems and/or which will provide the public and/or industry with a useful alternative.

It is acknowledged that the term ‘comprise’ may, under varying jurisdictions be provided with either an exclusive or inclusive meaning. For the purpose of this specification, and unless otherwise noted explicitly, the term comprise shall have an inclusive meaning—i.e. that it may be taken to mean an inclusion of not only the listed components it directly references, but also other non-specified components. Accordingly, the term ‘comprise’ is to be attributed with as broader interpretation as possible within any given jurisdiction and this rationale should also be used when the terms ‘comprised’ and/or ‘comprising’ are used.

Further aspects of the present invention will become apparent form the ensuing description which is given by way of example only.

According to the invention, there is provided a method of assembling a baler apparatus for compacting and baling material, the method comprising the steps of:
arranging an upstanding sidewall on a base, the side wall comprising a rear side wall flanked by two lateral sidewalls which taper outwardly from the rear side wall, and applying sidewall to base fixing means to secure the base to the side wall;
positioning a front wall between the sidewalls and applying front wall to sidewall fixing means to secure the front wall to the side walls to thereby form a chamber defined by the base, the rear side wall, the two lateral side walls and the front wall, the chamber having an opening opposite the base for the reception of material into the chamber;
arranging a box section member on an outer face of the rear wall such that a portion of the box section member extends outside the chamber to a point above the chamber, and applying box section to rear wall fixing means to secure the box section member to the rear wall, and
connecting compaction means to the box section member using compaction means to box section fixing means.

The present invention provides of a kit of components which can be assembled into a complete baler apparatus, which gives the advantage that the components may be inter-stacked for transporting prior to assembly in a substantially flat pack arrangement.

Preferably, the compaction means comprises a compaction plate coupled to actuator means, and the step of connecting the compaction means to the box section member comprises the further steps of:
connecting a compaction arm of the actuator means to the portion of the box section member that extends above the chamber using compaction arm to box section fixing means;
connecting biasing means between the compaction arm and the box section member using biasing means fixings;
pivotally connecting a compaction drop arm of the actuator means to the compaction arm using compaction drop arm to compaction arm fixing means;
connecting the compaction drop arm to the compaction plate using compaction drop arm to compaction plate fixing means.

Preferably, the various fixing means, namely the sidewall to base fixing means, crossbar to sidewall fixing means, front wall to sidewall fixing means, box section to rear wall fixing means, compaction means to box section fixing means, compaction arm to box section fixing means, biasing means fixings, compaction drop arm to compaction arm fixing means and the compaction drop arm to compaction plate fixing means are each provided by one or more, or a combination, of: nuts, bolts, screws, pins, washers, adhesives and other fasteners, joining devices and methods of joining two or more items together, including welding.

Thus the present invention envisages the use of releasable fixing means (as in the case of nuts, bolts, screws, pins, washers and the like) and non-releasable fixing means (as in the case of using welding, permanent adhesives and the like) and where appropriate, combinations of the both releasable and non-releasable fixing means as required or as desired. Thus, and by way of example, the sidewall to base fixing means may be provided by welding the base to the sidewall, or by the use of bolts threaded through receiving bores formed between the base and side wall and secured with an appropriate complimentary nut. Alternatively, the sidewall to base fixing means may be provided by a combination of both welding and the use of bolts threaded through appropriately located receiving bores formed between the base and side wall and secured with an appropriate complimentary nut. The same applies mutatis mutandis to the other fixing means which may also be constituted by either or a combination of releasable and non-releasable fixing means as required or as desired. Reference in the following description to the use of one type of fixing means should therefore in no way be seen as limiting on the invention.

In another embodiment of the invention, the method comprises the further step of: arranging a crossbar such that it is positioned above the front wall so as to extend across the front face of the chamber between the lateral sidewalls, and then applying crossbar to sidewall fixing means to secure the crossbar to and between the lateral side walls.

In another embodiment of the invention, the method comprises the further step of: securing a hook or retainer to the crossbar.

Preferably, the front wall to sidewall fixing means are operable such that the front wall is outwardly pivotable from the side wall to provide a front opening for removal of a tied bale from within the chamber.

Preferably, the base comprises a plate having a lip which extends around at least a portion of a perimeter thereof, and the step of securing the base to the side wall comprises applying the sidewall to base fixing means between the lip and the side wall.

In another embodiment of the invention, the method comprises the further step of: attaching a removable door lock on an outer surface of the front wall.

In another embodiment of the invention, the method comprises the further step of: rotatably mounting ground engaging wheels on axles which are removably connected to the chamber.

Preferably, the step of connecting biasing means between the compaction arm and the box section member comprises coupling the biasing means between a compaction arm retainer of the compaction arm and an eyebolt which is adjustable on a spring retainer plate mounted on one side the box section member.

According to the invention, there is provided an apparatus for compacting and baling material comprising:

a base;
an upstanding side wall mountable on the base;
a front wall releasably connectable to the side wall;
the side wall adapted to be assembled on the base for forming with the front wall a chamber having an opening opposite the base for the reception of material into the chamber;
compaction means operable to compact material received in the chamber;
tie means for tying the compacted material into a bale;
whereby the front wall is outwardly pivotable from the side wall to provide a front opening for removal of the tied bale from within the chamber.

Preferably, the side wall comprises a rear side wall flanked by two lateral side walls which taper outwardly from the rear side wall to side edges of the front wall.

Tapering of the side wall will allow easy removal of a finished bale of compacted material, whilst also allow inter-stacking of the side walls of multiple apparatuses so that multiple apparatus can be packed together for transporting.

Preferably, the rear side wall and two lateral side walls are formed by pressing and folding a single piece of material, such as plate steel or other metal alloy. This contributes to added strength and speed of manufacturing.

In another embodiment of the invention, the base comprises a plate which is connectable to the rear side wall and two lateral side walls. This will further ensure that apparatus may be transported in a substantially flat pack arrangement.

Preferably, the base comprises an extension lip. Such a lip provides added stability during compaction and when removing a compacted finished bale from the chamber.

In another embodiment of the invention, the front wall is provided as a door which is formed by pressing and folding a single piece of material. Preferably, the material used is also steel, or other suitable composite, metal or metal alloy having at least a minimal required level of rigidity.

In another embodiment of the invention, a removable door lock is provided on an outer surface of the front wall.

In another embodiment of the invention, the tie means comprises at least one tie receiving through slot which is provided in the front wall. Preferably, the tie means comprises at least two tie receiving through slots. Preferably, each slot extends substantially the height of the front wall.

In another embodiment of the invention, an end of the slot has a narrowed or tapered portion. This is to facilitate holding of a bale strap.

In another embodiment of the invention, the compaction means comprises a compaction plate coupled to actuator means.

Preferably, the actuator means comprises a compaction arm which is pivotably coupled to the compaction plate via a compaction drop arm.

In another embodiment of the invention, the actuator means further comprises biasing means adapted to retain the compaction arm in an open non-compacting position. The advantage of this is that the compaction plate can be prevented from free falling thus making the apparatus safer to use.

In another embodiment of the invention, the biasing means is provided as a spring. Alternatively, the biasing means may be provided by a gas strut with a linkage system to the compaction arm.

In another embodiment of the invention, the compaction arm is pivotally coupled at one end to the chamber and has a handle at its free end. Preferably, the handle is two handed. This ensures maximum grip and maximum compaction.

Preferably, the compaction arm is detachable from the chamber.

In another embodiment of the invention, the apparatus further comprises ground engaging wheels which are rotatably mounted on axles which are removably connected to the chamber.

### DETAILED DESCRIPTION OF THE INVENTION

The invention will be more clearly understood from the following description of some embodiments thereof, given by way of example only, with reference to the accompanying drawings, in which:

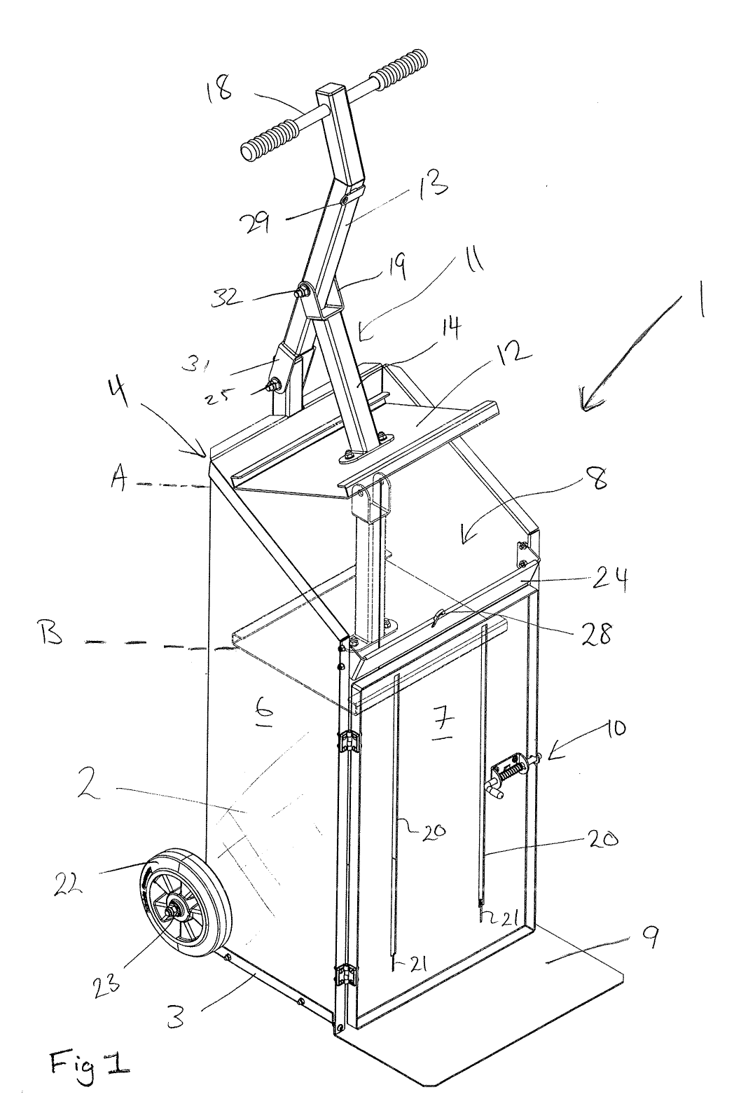

FIG. 1 is a front perspective view of an apparatus for compacting and baling material according to the invention;

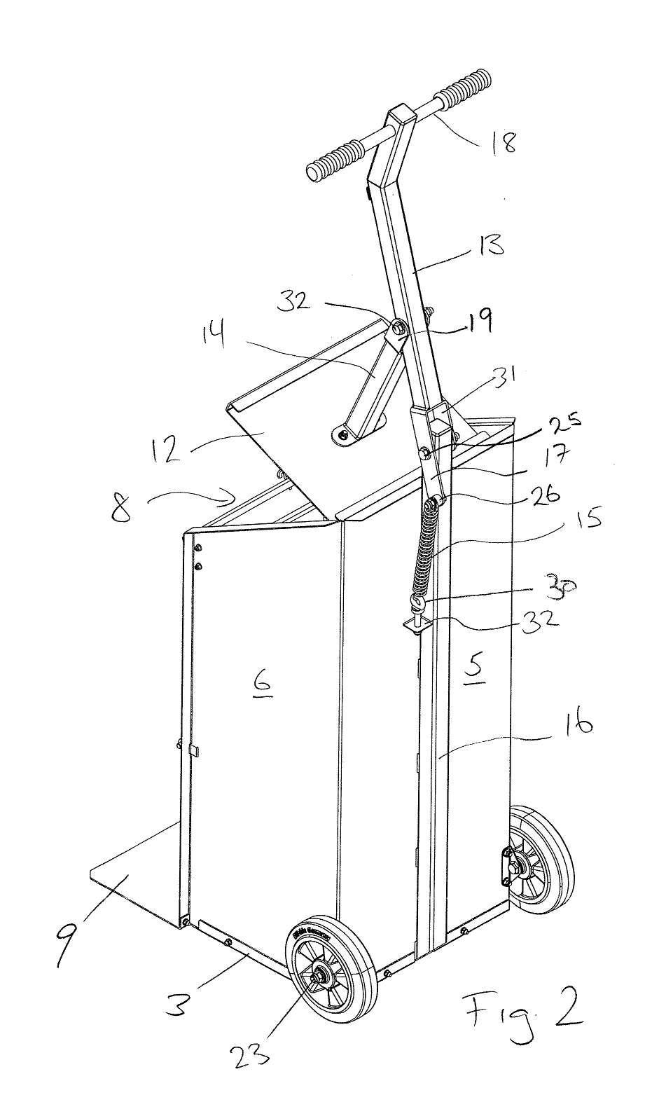

FIG. 2 is a rear perspective view of the apparatus shown in FIG. 1;

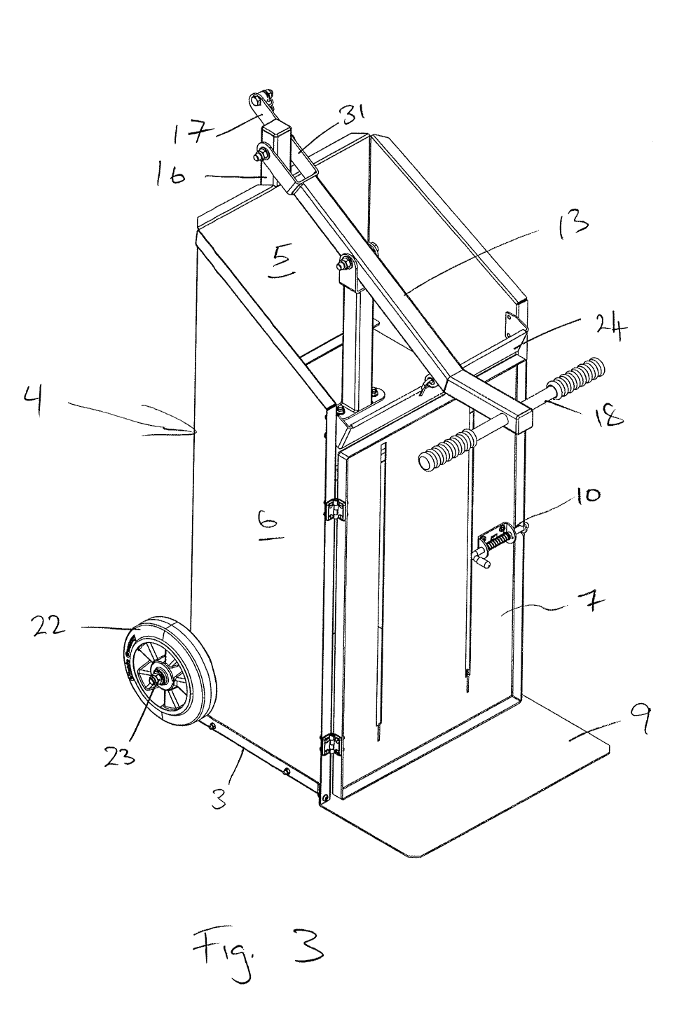

FIG. 3 is a front perspective view of the apparatus shown in FIG. 1, in which a compaction plate has been actuated to compress material;

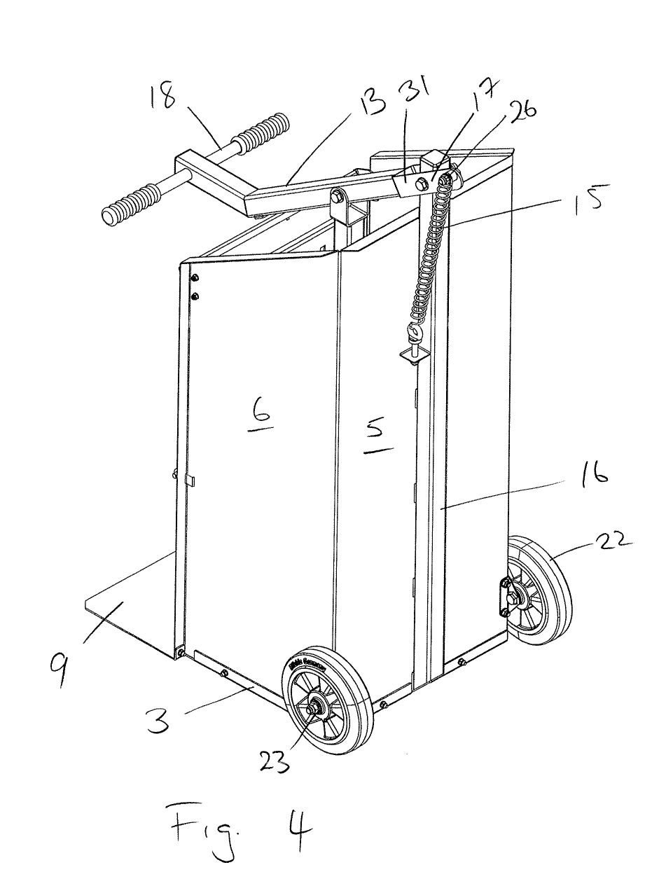

FIG. 4 is a rear perspective view of the apparatus shown in FIG. 3;

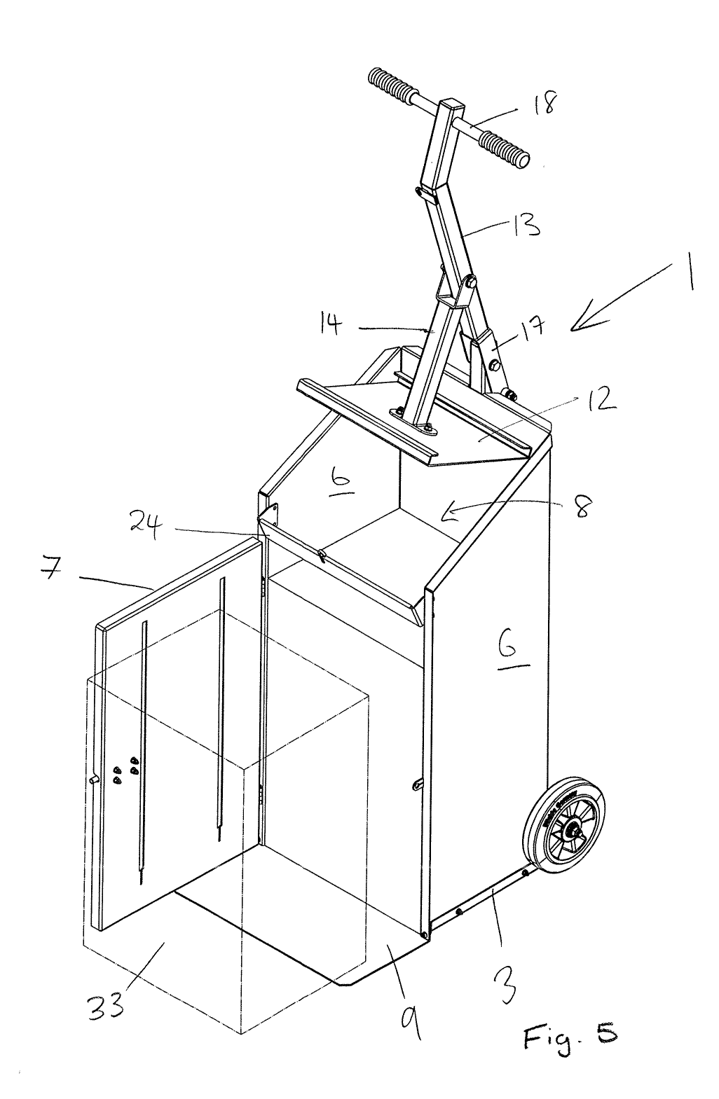

FIG. 5 is a front perspective view of the apparatus shown in FIG. 3, in which the compaction plate is upwardly pivoted and a compressed bale of material is being removed through a front wall of the apparatus;

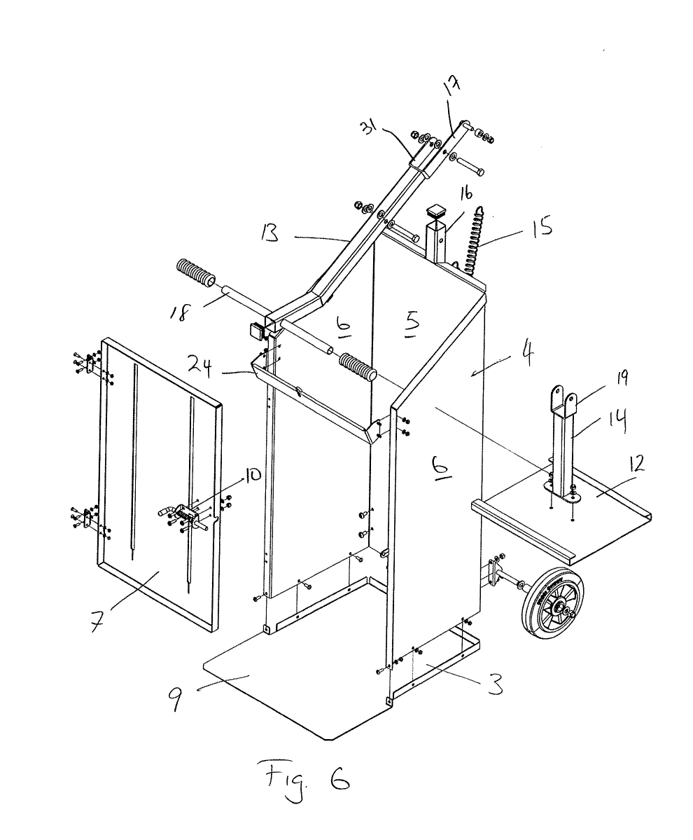

FIG. 6 is a front exploded view of the apparatus shown in FIG. 1;

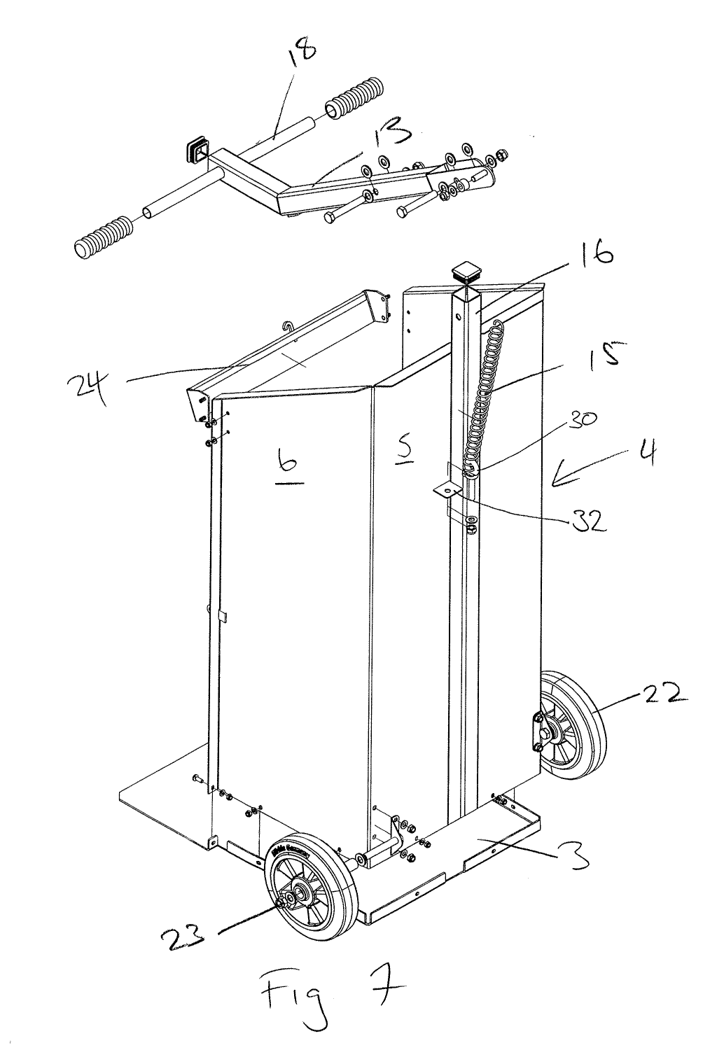

FIG. 7 is a rear exploded view of the apparatus shown in FIG. 1;

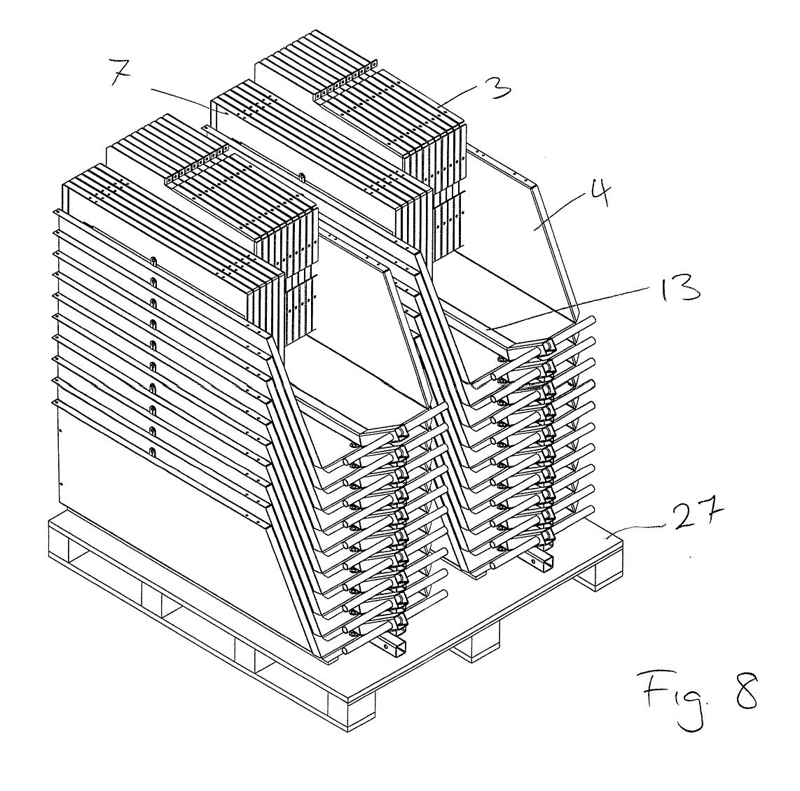

FIG. 8 is a front perspective view of a plurality of the apparatuses shown in FIG. 1, which is fully disassembled and stacked on a pallet for transporting;

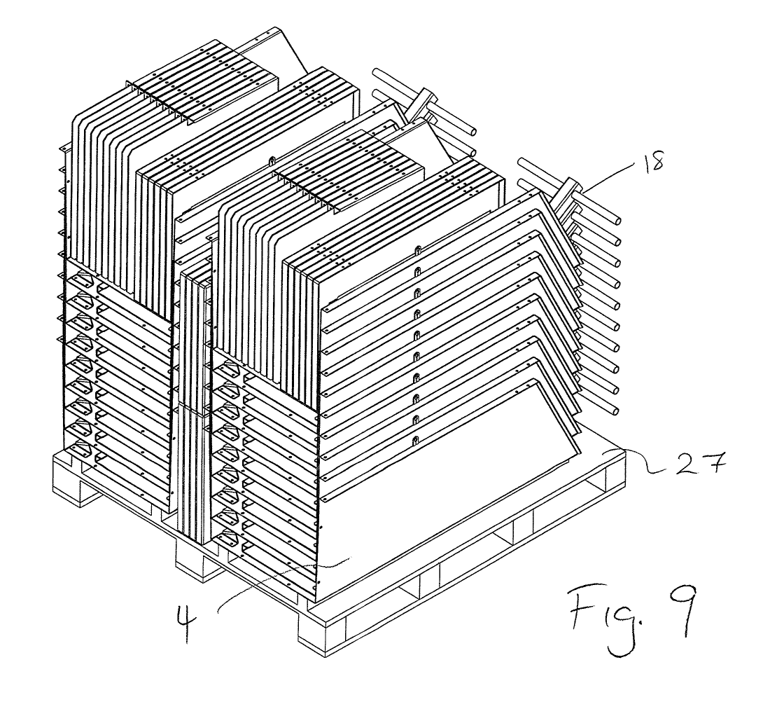

FIG. 9 is a rear perspective view of FIG. 8, and

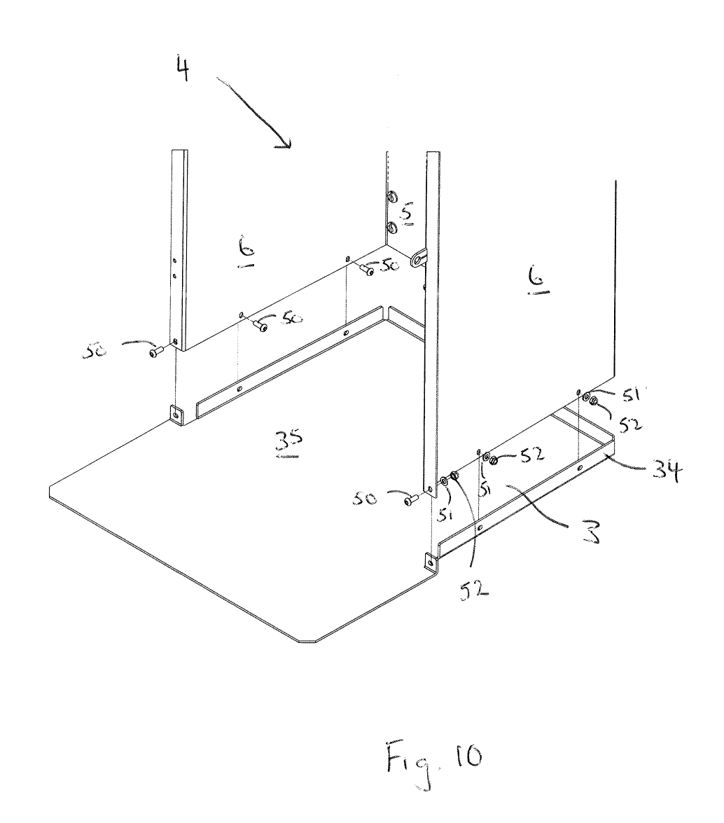

FIGS. 10 to 18 are perspective views showing steps in a method of assembling the baler according to the invention.

Referring to the drawings, and initially to FIGS. 1 to 7, there is shown an apparatus, indicated generally by the reference numeral 1, for compacting and baling material, indicated generally by the reference numeral 2, placed in the apparatus. Such material for compacting may be refuse, or other types of waste, including paper, cardboard, plastics, foil, cans and other like recyclable materials.

The apparatus 1 comprises a base 3 and an upstanding side wall 4 mountable on the base 3. The side wall 4 comprises a rear side wall 5 flanked by two lateral side walls 6. The rear side wall 5 and two lateral side walls 6 are formed by pressing and folding a single piece of material, such as plate steel material, metal, composite or other metal alloy. Also shown is a front wall 7 which is hinged to an edge of one of the lateral side walls 6 to form a door. The front wall 7 may also be formed by pressing and folding a single piece of material, such as plate steel material, metal, composite or other metal alloy. The base 3 is formed as a plate which is releasably connected to the rear side wall 5 and two lateral side walls 6. The base 3 also comprises an extension lip 9. The base 3, walls 5, 6 and front wall 7 are able to be assembled from a flat pack arrangement to form a chamber having an opening, indicated generally by the reference numeral 8, opposite the base 3 for the reception of material 2 for compacting into the chamber.

The front wall 7 is outwardly pivotable about a hinge or hinges and removable from the side wall 6 to provide a front opening for removal of material 2 which has been compacted and baled within the chamber. The lateral side walls 6 also taper outwardly from the rear side wall 5 to side edges of the front wall 7. Accordingly, in plan view the chamber would be substantially trapezoidal in shape. Such tapering will allow for easy removal of a finished compacted bale, whilst also facilitating flat packing of multiple apparatuses so that they can be interstacked together for transporting. A removable door lock, indicated generally by the reference numeral 10, is also provided on the front wall 7.

Also shown is compaction means, indicated generally by the reference numeral 11, which is operable to compact the material 2 placed in the chamber. In the instance shown, the compaction means 11 is provided by a compaction plate 12 which is releasably coupled to actuator means in the form of a compaction arm 13 which is pivotably coupled to the compaction plate 12 via a compaction drop arm 14. The compaction plate 12 is detachable for flat packing and comprises double pressed edges which add strength, and has round edges which to remove nip points making the baler apparatus 1 safer to use.

The actuator means further comprises biasing means, which in the instance shown is provided as a spring 15, which is adapted to apply a biasing force to retain the compaction arm 13 in an open non-compacting position. In an alternative embodiment however, such a biasing means may also be provided by a gas strut with a linkage system to the compaction arm 13.

The compaction arm 13 is releasably and pivotably connected to one end of a mounting 31 at a pivot 25 which extends through an upper end of a box section portion 16. It will be understood that the box section 16 is welded to the rear wall 5 to add strength to the chamber. The box section 16 may alternatively be bolted to the rear wall 5. Also shown is a compaction arm retainer 17 which projects from the mounting 31 and provides a connection 26 for one end of the spring 15, whilst the other end of the spring 15 is coupled to an eyebolt 30 which is adjustable on a spring retainer plate 32 to keep spring 15 appropriately tensioned. The spring retainer plate 32 is mounted one side of box section 16 to allow flat packing of apparatuses in that multiple apparatuses can be stacked together. The compaction arm retainer 17 is operable to create tension and assist the spring 15 in keeping the compaction arm 13 in an upper position clear of the opening 8 when not being used to compact. The compaction arm retainer 17 also extends a sufficient length from the mounting 31 which causes it to foul the rear wall 7 so as to prevent the compaction arm 13 from passing through the vertical. The advantage of this feature is a reduction of the overall space required for the apparatus 1. This also has the effect of making the apparatus 1 safer to operate as handles are actuated in a downward vertical action.

The compaction arm 13 is pivotally connected to the compaction drop arm 14 at the pivot 32 of a connection saddle 19. The connection saddle 19 is dimensioned and arranged relative to the compaction arm 13 so that when in the open position the compaction saddle 19 abuts against the compaction arm 13 to maintain a maximum feed opening for raw material 2. It will be understood that the compaction arm 13 is fully detachable from the apparatus 1 by unscrewing at pivot 32, and at connector 25. At the free end of the compaction arm 13 is a handle 18, which in the instance shown is two handed for maximum grip to provide maximum compaction force when in use.

Two tie receiving through slots 20 are provided in the front wall 7, each of which extends substantially the height of the front wall 7. The ends of the slots 20 each have a narrowed or tapered portion 21 to facilitate holding of a bale strap (not shown) which is used to tie a finished bale prior to removal from the chamber.

The apparatus 1 further comprises ground engaging wheels 22 which are rotatably mounted on axles 23 and removably connected to the chamber.

Also shown is crossbar 24 which is releasably connected between the lateral walls 6 and above the front wall 7. The crossbar 24, when connected, is sloped forward to facilitate a larger opening 8 through which material may be introduced into the apparatus 1. A hook 28 is also provided which engages with a handle retainer 29 on underside of the compaction arm 13 to provide a large feed opening when compaction arm 13 is in a raised position. The hook 28 and the retainer 29 are further operable together to lock the compaction mechanism, including the compaction plate and the actuator means 11, in the down position keeping pressure on the compacted material and therefore ensuring maximum compaction and giving a better compacted bale.

In use, a user (not shown) thus places waste material 2 to be compacted and baled into the chamber, comprising of the side wall 4 and base 3, and then actuates the compaction means 11 by gripping the compaction handle 18 and applying a downward pushing or pulling force to the compaction arm 13. This force is transferred via the drop arm 14 to the compaction plate 12 which then moves from an upward non-compacting position (denoted in FIG. 1 as position A) in which material may be placed into the chamber, to a downward compacting position (denoted in FIG. 1 as position B) to thereby compact and crush material 2 in the apparatus 1. When sufficient material 2 has been compacted it may then be tied to form a bale 33 whilst still in the chamber 3, 4 using twine, string, rope, belts or the like which had been pre-threaded via slots 20 prior to placement of material 2 into the chamber. The front wall 7 is opened and the bale of compacted material 33 is able to be removed (as shown in FIG. 5). The tapered substantially trapezoid shape of the chamber 3, 4 makes the removal of the finished bale significantly easier.

FIGS. 6 and 7 show the apparatus 1 in exploded form and emphasis the way the various components of the apparatus 1, and notably the larger components of the base 3, side wall 4, front wall 7 and compaction means including the compaction arm 13 and compaction plate 12 are all detachable coupled together by nuts, bolts, screws or the like connection means which facilitate detachability of the apparatus components. It will also be understood that some of the components, notably the may alternatively be connected by welding together, This provides huge advantages since the apparatus 1 may be transported very efficiently on pallets 27, as is shown in FIGS. 8 and 9. In particular, it will be noted that the side walls 4 are able to be inter-stacked due to their trapezoidal shape, and the front wall 7, base 3 and compaction arm 13 and other components needed to form a fully arranged apparatus 1 are all able to be stacked within the inter-stacked side walls 4. Accordingly, the base 3, sidewall 4, front wall 7 and cross bar 24 when disassembled ensures that the whole chamber can effectively be flat packed. In the instance shown, the pallet 27 is transporting twenty or more fully equipped apparatuses 1, which can then be assembled at an intended destination. However, it be understood that the arrangement shown in FIGS. 8 and 9 are exemplary only and that the number of apparatuses 1 can be inter-stacked as required or as desired, and may be dependent on the size of the pallet 27 and or the number of apparatuses 1 needing to be transported. Were the apparatuses 1 not formed according to the present invention it is considered that at most four assembled apparatuses 1 would be able to be comfortably and safely stacked on the pallet 27.

FIGS. 10 to 17 are perspective views showing steps in a method of assembling the baler according to the invention. FIG. 10 shows a first step in which the upstanding sidewall 4 is arranged on the base, the side wall 4 comprising a rear side wall 5 flanked by two lateral sidewalls 6 which taper outwardly from the rear side wall 5. The base 3 comprises a plate 35 having a lip 34 which extends around at least a portion of a perimeter of the plate 35. The step of securing the base 3 to the side wall 4 comprises applying sidewall to base fixing means between the lip 34 and the side wall 4. In the instance shown, the sidewall to base fixing means is provided by bolts 50, washers 51, and lock nuts 52, whereby the bolts 50 are inserted from inside the sidewall 4 through the lip 34 at desired positions and a washer 51 and nut 52 is fastened to the end of each bolt 50 on the outside of the sidewall 4. It will be understood that the sidewall to base fixing means may alternatively be provided by, or further complimented, by welding the sidewall 4 to the base 3.

In a further step, a box section member 16 is positioned on an outer face of the rear wall 5 such that a portion of the box section member 16 extends outside the chamber to a point above the top edge of the rear wall 5. A box section to rear wall fixing means in the form of welding is applied to weld the box section member to the rear wall. It will be understood that this step may take place before connecting the base 3 to the side wall 4, that is, the box section member 16 is already welded to the rear wall 5 before assembly of the baler unit begins.

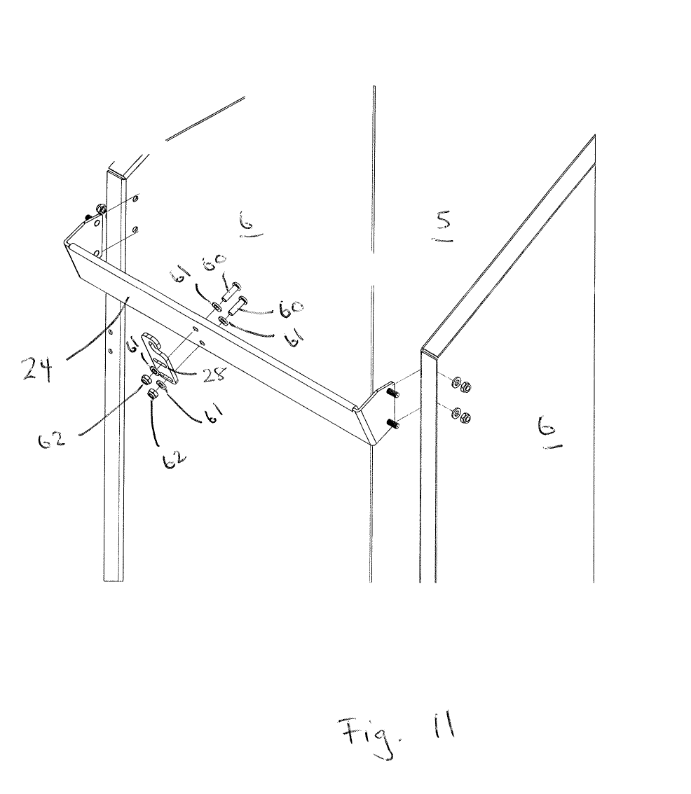

FIG. 11 shows a step of arranging the crossbar 24 so that it is positioned to extend between the lateral sidewalls 6 above where a front wall door will be fitted. A crossbar to sidewall fixing means is then applied to secure the crossbar 24 to the lateral side walls 6. In the instance shown, the crossbar to sidewall fixing means is provided by bolts 60, washers 61 and lock nuts 62. A securing a hook or retainer 28 is also secured to an outside face of the crossbar 24 using the crossbar to sidewall fixing means, although the bolts 60 are run from the inside to the outside of the crossbar but left initially loose and tightened when the compaction arm 13 is in place and the hook 28 can be aligned over a hole in the compaction arm retainer 29.

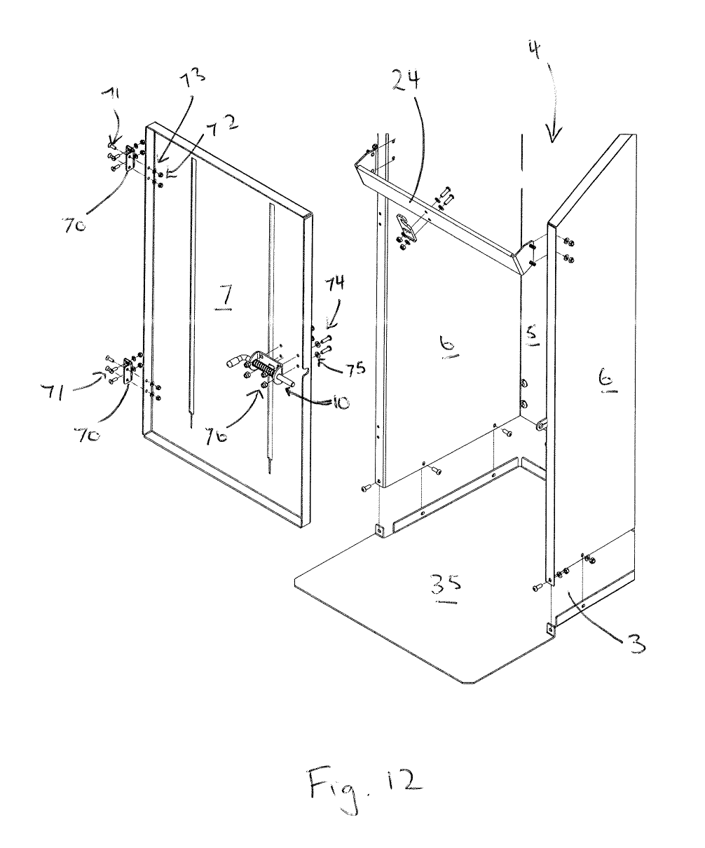

FIG. 12 shows a step of positioning the front wall 7 between the sidewalls 6 and applying front wall to sidewall fixing means to secure the front wall 7 to the side walls 6 to thereby form a chamber defined by the base 3, the rear side wall 5, the two lateral side walls 6 and the front wall 7. The chamber 3, 4, 6, 7 has an opening opposite the base 3 for the reception of material therein. The front wall to sidewall fixing means comprises applying hinges 70 to the front wall door 7 and then the door 7 to the side walls 6 using the bolts 71, nuts 72 and washers 73. A door lock 10 is secured to an outer surface of the front wall 7 using bolts 74 with flat washers 75 and lock nuts 76, whereby a washer 75 is threaded onto each bolt 74 with the bolt 74 being passed out through the front wall 7 from the inside face of the front wall 7, then through the door lock 10 and a lock nut secured to the free end of the bolt. The front wall to sidewall fixing means are operable such that the front wall 7 is outwardly pivotable from the sidewall 4 to provide a front opening for removal of a tied bale from within the chamber.

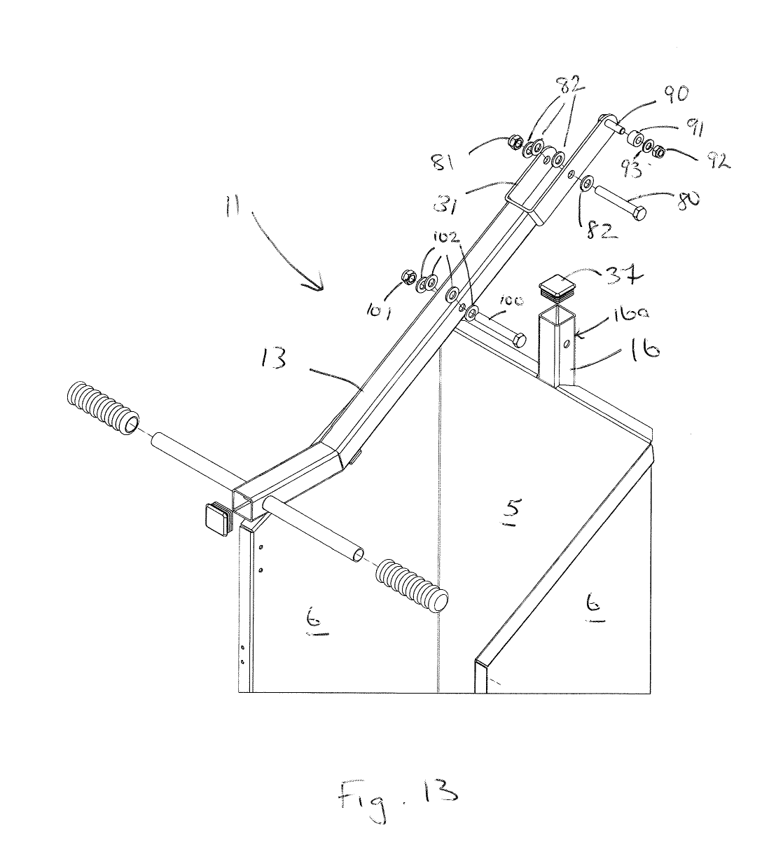

FIG. 13 shows a step of connecting compaction means 11 to the box section member 16 using compaction means to box section fixing means, the step comprising connecting a compaction arm 13 of the actuator means 11 to the portion 16a of the box section member 16 that extends above the rear wall 5 using compaction arm to box section fixing means. The compaction arm to box section fixing means comprises applying bolts 80, nuts 81 and washers 82 through bores between box section 16a and mounting 31 of the compaction arm 13. Bolt 80 is passed through one side of compaction arm mounting 31 and then through the box section portion 16a. A washer 82 is placed on each side of the box section 16a as the bolt passes through it. A further washer 82 and lock nut 81 is threaded to the end of the bolt 80 and securely tightened. A plastic end cap 37 is then inserted into the end of the box section 16.

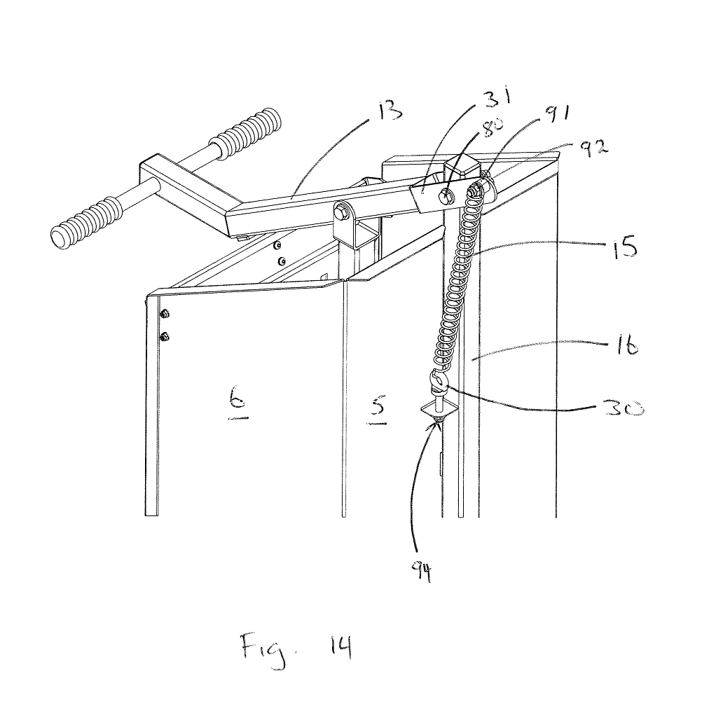

FIGS. 13 and 14 shows a step of connecting biasing means, in the form of a spring 15, between the compaction arm mounting 31 and the box section member 16 using biasing means fixings. Initially, and as shown in FIG. 13, biasing means fixings, in the form a nut 91 and spring retainer bolt 90 are threaded onto the compaction arm mounting 31. The retention spring 15 is secured to the bolt 90 which projects from the mounting 31 using washers 93 and nut 94 which are threaded onto the end of the bolt 90. A washer 93 may be placed each side of the spring with the nut 92 tightened on the outside. The compaction arm 13 is then raised into an upper position to remove tension on the spring and the spring 15 is connected to an eyebolt 30 which is adjustable on a spring retainer plate 32 mounted on one side the box section member 16. The eyebolt 30 is adjusted on the plate 32 to the required length by adjusting a further washer and nut arrangement 94, which are threaded onto the eyebolt underneath the plate 32.

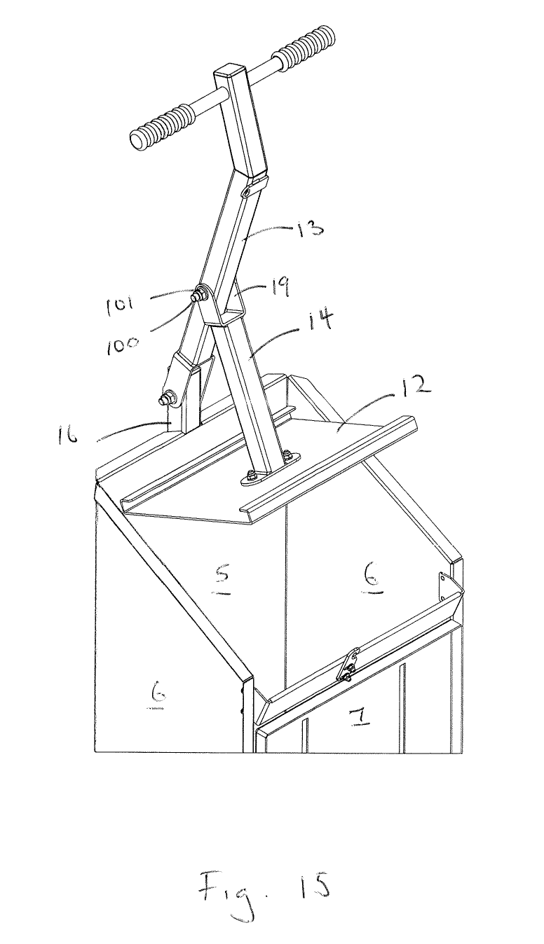

FIGS. 13 and 15 shows a step of connecting a compaction drop arm 14 of the actuator means 11 to the compaction arm 13 using compaction drop arm to compaction arm fixing means, which are shown in FIG. 13, and comprise a bore which extends through the compaction arm 13 and through the connection saddle 19. The through bores in the arm 13 and saddle 19 are aligned and a bolt 100 is pushed through the bore. A nut 101 and washers 102 are connected to the bolt 100 using the same approach as was used to connect the compaction arm 13 to the box section 16 above.

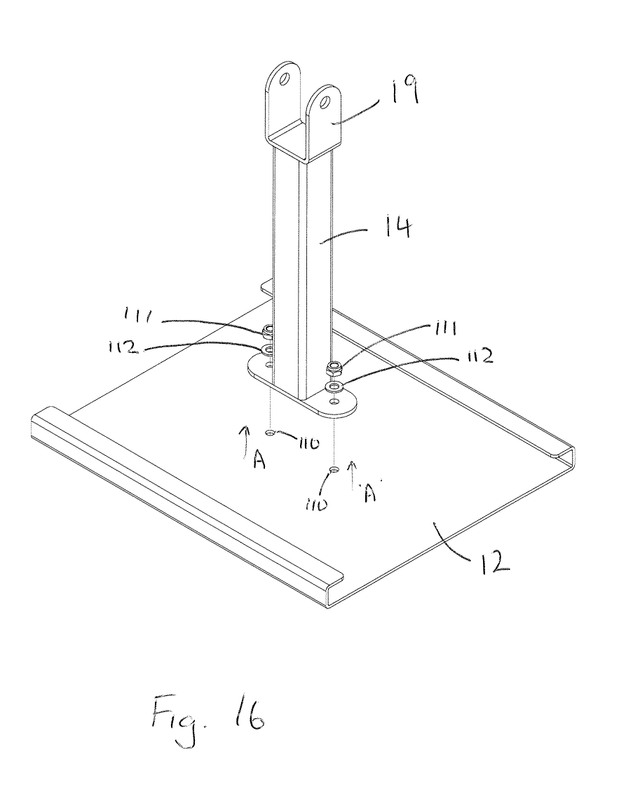

FIG. 16 shows a step of connecting the compaction drop arm 14 to the compaction plate 12 using compaction drop arm to compaction plate fixing means in the form of bolts (not shown) which extend up through bores 110 in the plate 12 in the direction of arrow ‘A’, and nuts 111 and washers 112. A washer 112 is placed on each bolt next to the bolt head and one next to the nut 111, which is tightened securely to ensure that the compaction plate 12 is square with the rear wall 5.

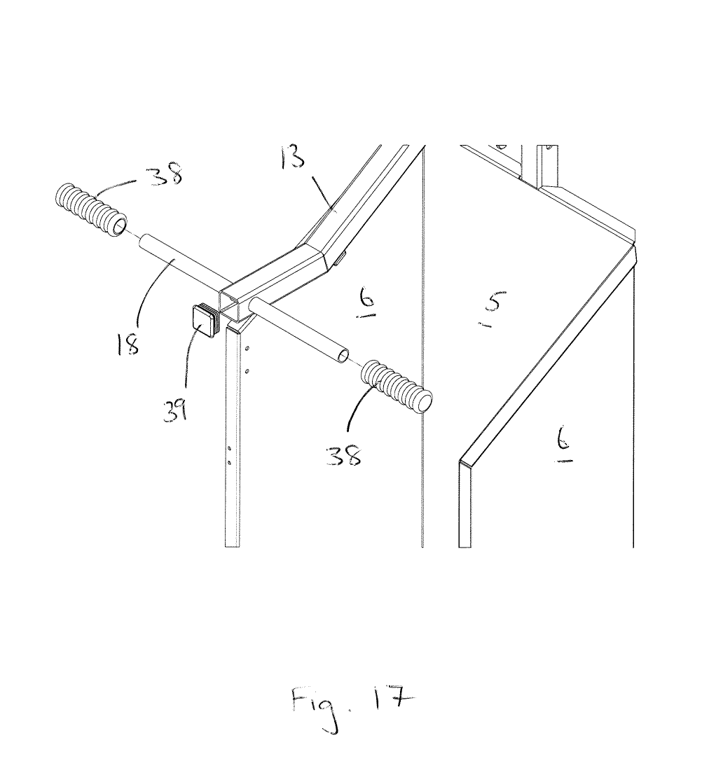

FIG. 17 shows a step of inserting two plastic handle grips 38 onto the handle 18 of the compaction arm 13. A further end cap 39 is inserted into the box section end of the compaction arm 13.

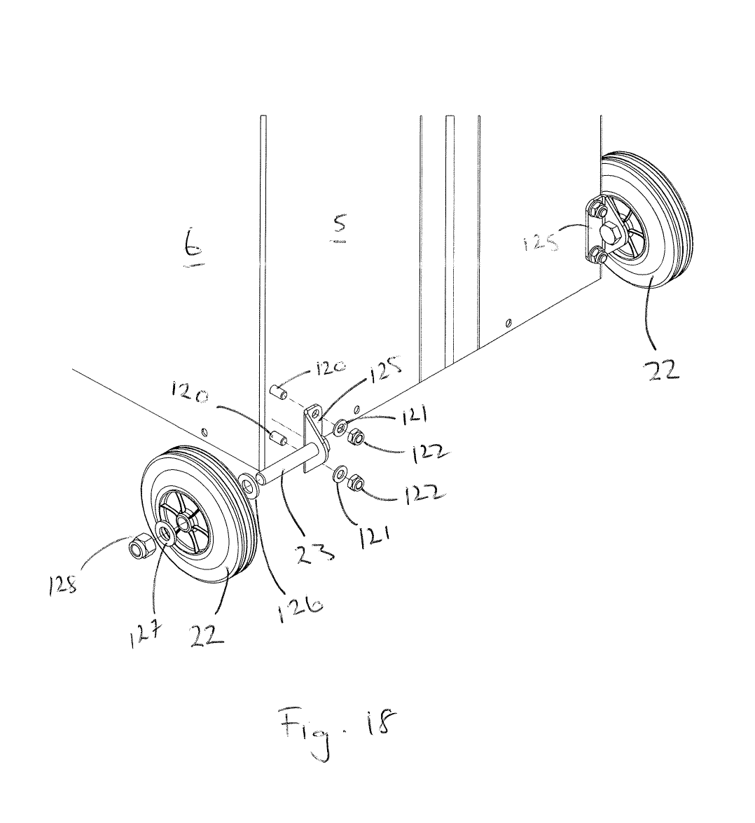

FIG. 18 shows a step of rotatably mounting ground engaging wheels 22 on axles 23 which are removably connected to the rear wall 5. If wheels are to be fitted the axles 23 are bolted to rear wall via wheel bracket 125 using bolts 120, the bolts 120 passing through the rear wall 5 from the inside to the outside of the rear wall 5 through the bracket 125. A washer 121 is placed next to the nut 122 before the nut 122 is fastened. A bushing 126 is threaded onto the axle 23 followed by the wheel 22, a further washer 127 on the outside followed by the lock nut 128, which is then tightened securely making sure wheel is free to rotate.

When the baler is fully assembled, the compaction arm 13 should be raised into the upper/open position. If the arm 13 does not remain fully up, it may be necessary to tighten the nut 81 to keep it in the upper position. Tensioning the retainer spring by tightening the nut 94 will also assist. The compaction arm retainer catch 28 may be aligned and secured by tightening the nuts 62 on bolts 60.

Although reference in the foregoing description made use of releasable fixing means (as in the case of nuts, bolts, screws, pins, washers and the like), it will be understood that and non-releasable more permanent fixing means (as in the case of using welding, permanent adhesives and the like) could also be used where appropriate, as could combinations of the both releasable and non-releasable fixing means as required or as desired. Reference in the following description to the use of one type of fixing means, such as nuts, bolts, washers, or welds should therefore in no way be seen as limiting on the invention.

Aspects of the present invention have been described by way of example only and it should be appreciate that additions and/or modifications may be made thereto without departing from the scope thereof as defined in the appended claims.

1. A method of assembling a baler apparatus for compacting and baling material, the method comprising the steps of:
arranging an upstanding sidewall on a base, the side wall comprising a rear side wall flanked by two lateral sidewalls which taper outwardly from the rear side wall, and applying sidewall to base fixing means to secure the base to the side wall;
positioning a front wall between the sidewalls and applying front wall to sidewall fixing means to secure the front wall to the side walls to thereby form a chamber defined by the base, the rear side wall, the two lateral side walls and the front wall, the chamber having an opening opposite the base for the reception of material into the chamber;
arranging a box section member on an outer face of the rear wall such that a portion of the box section member extends outside the chamber to a point above the chamber, and applying box section to rear wall fixing means to secure the box section member to the rear wall, and
connecting compaction means to the box section member using compaction means to box section fixing means.

2. The method of assembling a baler apparatus as claimed in claim 1, in which the compaction means comprises a compaction plate coupled to actuator means, and the step of connecting the compaction means to the box section member further comprises the step of connecting a compaction arm of the actuator means to the portion of the box section member that extends above the chamber using compaction arm to box section fixing means.

3. The method of assembling a baler apparatus as claimed in claim 2, in which the method comprises the further step of connecting biasing means between the compaction arm and the box section member using biasing means fixings.

4. The method of assembling a baler apparatus as claimed in claim 2, in which the method comprises the further step of pivotally connecting a compaction drop arm of the actuator means to the compaction arm using compaction drop arm to compaction arm fixing means.

5. The method of assembling a baler apparatus as claimed in claim 2, in which the method comprises the further step of connecting the compaction drop arm to the compaction plate using compaction drop arm to compaction plate fixing means.

6. The method of assembling a baler apparatus as claimed in claim 1, in which the method comprises the further steps of arranging a crossbar such that it positioned above the front wall so as to extend across the front face of the chamber between the lateral sidewalls, and then applying crossbar to sidewall fixing means to secure the crossbar to and between the lateral side walls.

7. The method of assembling a baler apparatus as claimed in claim 6, in which the method comprises the further step of securing a hook or retainer to the crossbar.

8. The method of assembling a baler apparatus as claimed in claim 1, in which the base comprises a plate having a lip which extends around at least a portion of a perimeter thereof, and the step of securing the base to the side wall comprises applying the sidewall to base fixing means between the lip and the side wall.

9. The method of assembling a baler apparatus as claimed in claim 1, in which the method comprises the further step of attaching a removable door lock on an outer surface of the front wall.

10. The method of assembling a baler apparatus as claimed in claim 1, in which the method comprises the further step of rotatably mounting ground engaging wheels on axles which connect to the rear wall or the base.

11. The method of assembling a baler apparatus as claimed in claim 1, in which the step of connecting biasing means between the compaction arm and the box section member comprises coupling the biasing means between a compaction arm retainer of the compaction arm and an eyebolt which is adjustable on a spring retainer plate mounted on one side the box section member.

12. A baler apparatus assembled according to claim 1.

13. The method of assembling a baler apparatus as claimed in claim 3, in which the method comprises the further step of pivotally connecting a compaction drop arm of the actuator means to the compaction arm using compaction drop arm to compaction arm fixing means.
